(19) United States
(12) Patent Application Publication
(10) Pub. No.: US 2009/0283116 A1
(43) Pub. Date: Nov. 19, 2009

(54) Jetted Fluid System Cleaning Device and Method of Use Thereof

(76) Inventor: Alex Jurim, Littleton, CO (US)

Correspondence Address: Leyendecker & Lemire, LLC, C/O PORTFOLIO IP, P.O. BOX 52050, MINNEAPOLIS, MN, 55402, US

(21) Appl. No.: 12/121,308

(22) Filed: May 15, 2008

(51) Int. Cl. B08B 9/027; E04H 4/16

(52) U.S. Cl. 134/22.12; 134/167 C; 15/104.061

(57) ABSTRACT

One embodiment of a jetted fluid system cleaning device may comprise an inlet port, an outlet port, at least one tube, and a sanitation system. The inlet port is adapted to receive a fluid and may be adapted to couple to a jetted bathtub faucet. The at least one tube may be coupled to the inlet port and adapted to transport the fluid from the inlet port to the fluid outlet port whereupon the fluid outlet port may be adapted to release the mixture to a jetted system intake port. The sanitation system in one embodiment may be operatively coupled to the at least one tube and adapted to insert a cleaning solution to the fluid to create a solution-fluid mixture.

### FIELD OF THE INVENTION

This invention generally relates to jetted water systems.

### BACKGROUND

Jetted water systems such as, but not limited to, bath tubs that comprise jets, such as but not limited to Jacuzzi® or other similar type jets, oftentimes have water lines connecting the jets to a water intake system. After usage of the system over time, bacteria, mold, mildew, soap scum, and other unwanted items may cause a sludge-like build-up in the lines. These unwanted items may continue to grow between jet usage periods.

There are many problems associated with the buildup of unwanted items in jetted water system lines. For example, these unwanted jet line items may negatively affect the health of a user of a jetted tub system or other systems that use jetted water such as, but not limited to, pedicure stations. One example of this is bacteria causing skin rashes to occur on the users of these systems. Other health problems may also occur. Mechanical problems may also be associated with a sludge-like build-up of unwanted items in the system lines. For example, the water jets may not function properly due to low water pressure or due to blocked lines. Other mechanical problems may also occur. Lastly, there is a problem associated with this buildup is the lack of clean water. Having cleaner water—both visually, aromatically, and otherwise, is a desire for most people when they use jetted water systems.

Therefore, a cheap, safe, and useful system adapted to clean the water lines of jetted water systems is needed.

### SUMMARY OF THE DRAWINGS

FIG. 1A is an isometric view of a jetted line cleaning device according to one embodiment of the invention.

FIG. 1B is a side cross-sectional view of a hose connector according to one embodiment of the invention.

FIG. 2 is a partial cross-sectional side view of a sanitation system coupled to a pair of tubes according to one embodiment of the invention.

FIG. 3 is a cross-sectional isometric view of an outlet port according to one embodiment of the invention.

FIG. 4 is a perspective view of a jetted bathtub with a jetted line cleaning device coupled to a bathtub faucet and a jet line water intake port (as seen through the cutaway fluid outlet port) according to one embodiment of the invention.

FIG. 5 is an isometric view of a fluid intake port according to one embodiment of the invention.

FIG. 6 is a side view of a fluid intake port coupled to a faucet according to one embodiment of the invention.

### DETAILED DESCRIPTION

One embodiment of the invention is a device that may operatively couple a jetted water system water outlet port such as, but not limited to, a faucet, to a jet system water intake port. Upon allowing water to exit the outlet port, the system is adapted to insert a cleaning solution to the water and subsequently send this water-solution mixture to the inlet port. Upon powering on the water jets, the jet system intake port receives the water-solution mixture and sends this mixture through the system, substantially cleaning and disinfecting the tubes, and removing bacteria and mold from the inner surface of the tubes and the jets. Ultimately, the solution in ejected from the jets into the tub, exiting the tub through the drain. In one embodiment, the cleaning solution may include a growth prevention agent adapted to substantially prevent mold, bacteria, and other unwanted items from being regenerated within the internal jet tubes and jets upon proper use of the solution.

One embodiment of a jet tube flush system may be comprised of a water reception port, at least one tube, a sanitation system having a cleaning solution, and a water intake coupling mechanism. One water reception port may be comprised of a flexible polymeric or elastomeric device having a conduit. One end of the conduit may be adapted to receive a faucet and may include a flexible strap, which may be used to couple the inlet port to the faucet. The at least one tube in one embodiment may be corrugated polymeric tubing adapted to couple to the sanitation system and transfer the mixture to the jet lines. In one embodiment, the sanitation system comprises a device adapted to release an amount of cleaning solution into the water over a set period of time for a given flowrate—for example, through a venturi valve. One venturi valve may induce a venturi flow or may only be referred to as a venturi valve.

Upon receiving the solution from the sanitation system, the mixture may flow through a corrugated tube to the water intake coupling mechanism. One water intake coupling mechanism may be adapted to sealedly transfer the mixture to the jetted system water reception port. One water intake coupling mechanism may be substantially universally adapted to allow the system to be used with any or nearly any bath tub water intake port and water outlet port. Upon running through and cleaning the tubing and piping of the jetted water system, the mixture exits the jets and flows down the drain.

In this manner and with such a device, jetted water systems, also known as water jet systems, are cleaned and made to provide a fresh feel, keeping people safe from the harmful affects of unclear and mechanically unsound jetted water systems.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple”, “coupled”, “coupling”, or any variation thereof, as used in this specification and the appended claims refers to either an indirect or direct connection between the identified elements, components or objects. Often the manner of the coupling will be related specifically to the manner in which the two coupled elements interact. Specifically, this term may be used to define tow elements joined by a bolted fastener, a latch, a hook, or any other reasonably readily removable fastening device.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

The terms “bacteria”, “mold”, “mildew” and other terms having similar connotations refer to microorganisms, fungus, or other type of growth typically found to live in soil, water, organic matter, or the bodies of plants and animals.

The terms “mixture”, “solution”, “fluid” and all other terms referring to similar substances are meant to be inclusive and not specifically defining a certain type or classification. These terms refer to both homogeneously mixed and non-homogeneously mixed liquids. Each may refer to a liquid or liquid-type substance typically having more than one constituent.

### One Embodiment of a Jet Tube Flush System:

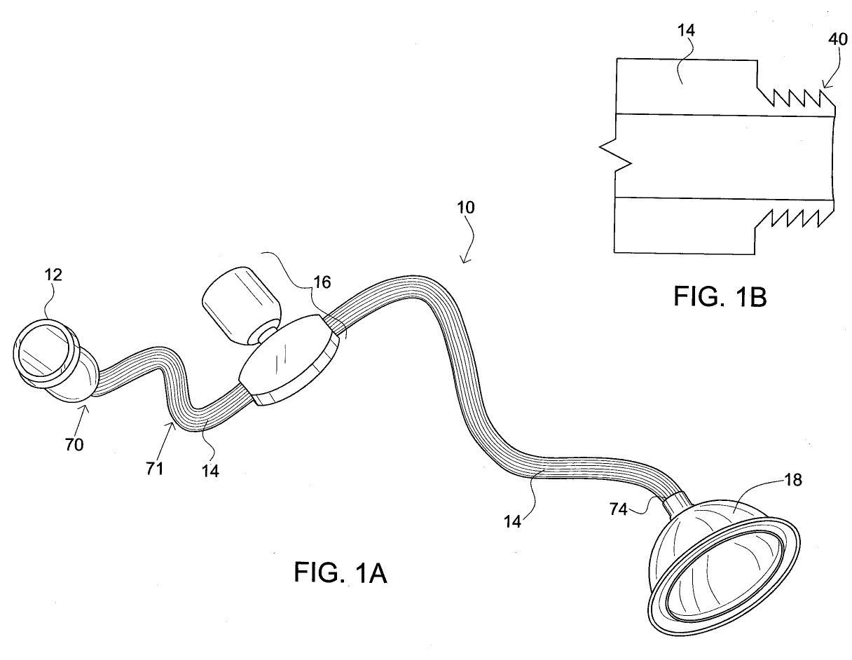

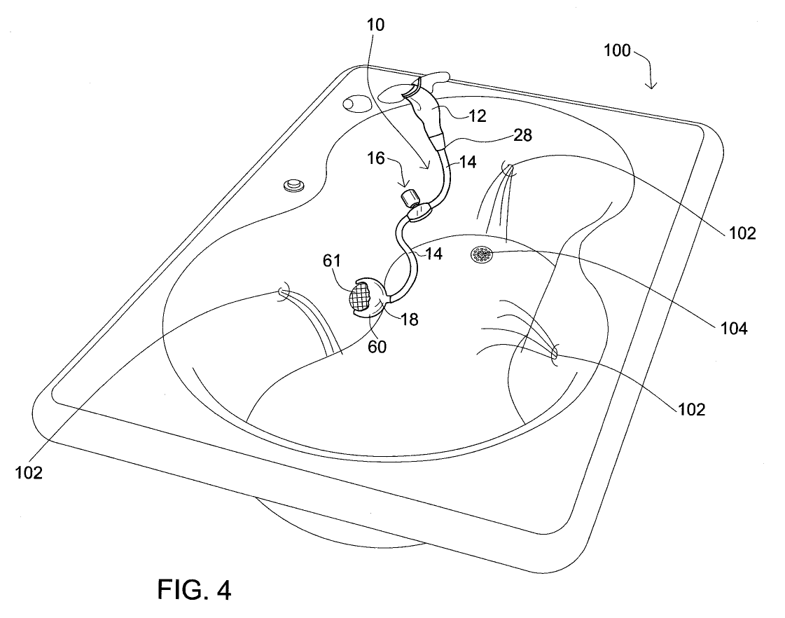

As best seen in FIGS. 1A through 3 and FIGS. 5 and 6, one embodiment of a fluid jet system cleaning device 10 may be comprised of a fluid inlet port 12, at least one tube 14, a sanitation system 16, and a fluid outlet port 18. One fluid jet system cleaning device may also be referred to as a jetted line cleaning device. In one embodiment, the device is adapted to work with a jetted water system such as, but not limited to, a bathtub having Jacuzzi® jets or another similar bathtub, as shown in FIG. 4.

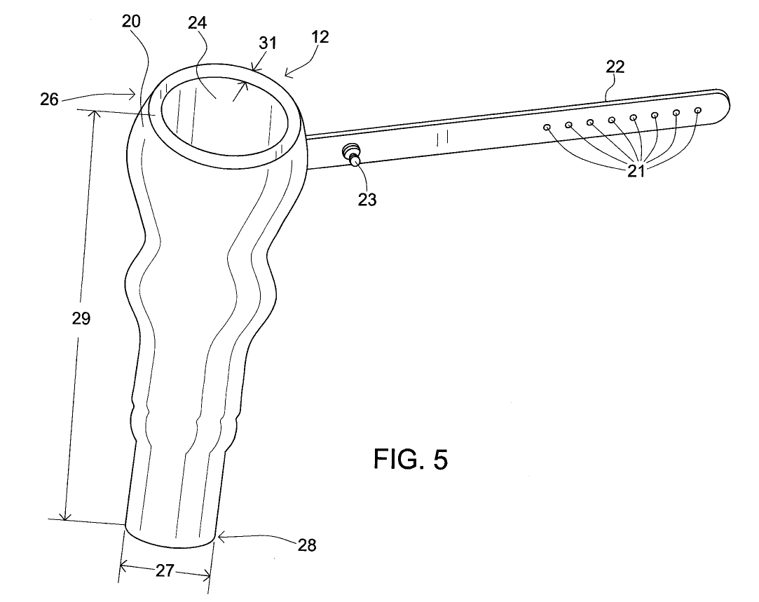

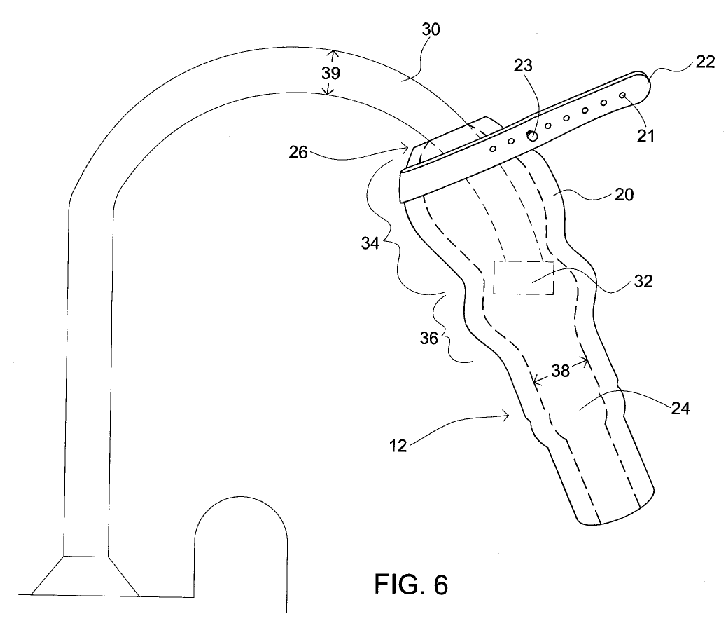

As seen in FIG. 5, one embodiment of a fluid inlet port 12 may be comprised of a conduit section 20 and a strap section 22. The inlet port may also be referred to as a water reception port. One conduit section may be comprised of bore 24 extending from a conduit proximal end 26 to a conduit distal end 28. One conduit section may be comprised of a generally flexible polymeric material such as, but not limited to an elastomer such as, but not limited to synthetic polyisoprene. The bore at the proximal end is adapted to receive a faucet 30 in one embodiment, as best shown in FIG. 6. As the proximal end may be adapted to couple to various different types of faucets, it may be referred to as a universal adapter. The distal end is of the conduit is adapted to couple to a tube 14, as best seen in FIG. 4.

As shown in FIG. 5, the conduit may have a length 29 of about 9.36 inches in one embodiment, and may have a varying width 27 of about 1.5 inches at the distal end 28 and about 3 inches at a first bulbous portion 34, as shown in FIG. 6. The thickness 31 of the conduit material may be about 0.25 inches near the distal end and about 0.125 inches around the proximal end 26 and the first bulbous and a second bulbous 36 portion, as shown in FIG. 5. The bore diameter 38 may vary according to location along the conduit and the conduit's width and thickness.

The strap section 22 of one embodiment may be referred to as a faucet coupling mechanism or simply a coupling mechanism. The strap section may be comprised of a flexible elastomeric or polymeric material such as, but not limited to synthetic polyisoprene. As shown in FIG. 5, one strap section may extend generally perpendicularly as compared to the longitudinal axis of the bore 24, when the strap is fully extended. Furthermore, the strap may be comprised of a plurality of bores 21 and a strap extension 23.

As shown in FIG. 6, the strap 22 may be adapted to couple the fluid inlet port 12 to the faucet 30. To do so, in one embodiment, a faucet end 32 may be inserted into the conduit section bore 24. The conduit section 20 may be shaped to receive the faucet end. For example, one of the first and second bulbous portions may be adapted to receive the faucet end 32. Upon insertion of the faucet end into the bore to the second bulbous portion in one embodiment, the strap may be wrapped around the first bulbous portion, squeezing the conduit. In one embodiment, conduit is squeezed in order to decrease the bore diameter 38. For example, the bore diameter proximate the strap may generally equal a faucet diameter 39 upon squeezing the conduit. Pressing the bore around the faucet may ensure that the inlet port 12 stays coupled to the faucet and, upon turning on of the faucet, may limit the amount of water which exits the bore from the proximal end 26.

As best seen in FIGS. 1A and 4, in one embodiment, the inlet port 12 may couple to a tube 14. One tube may also be referred to as a hose. In one embodiment, the tube may be flexible tubing. Furthermore, the tubing may be corrugated and may be comprised of a polymeric material such as, but not limited to polyurethane. The tubing is adapted to transfer the water from the inlet port to the outlet port 18. As shown in FIG. 1B, the tubing may be comprised of a press-plug connector 40. Other the press-plug connector may also be referred to as a hose connector. Other hose connectors, such as, but not limited to a threaded hose connector, are also contemplated. The press-plug connector may be a male connection portion adapted to be inserted into a female portion of the inlet or outlet ports. For example, one press plug connector may be inserted to bore 24 at the distal end 28 of the inlet port, as best shown in FIG. 5. A system may be comprised of a first tube proximal end 70, a first tube distal end 72, a second tube proximal end 73 and a second tube distal end 74. There may also be a first tube center portion 71 and a second tube center portion 75.

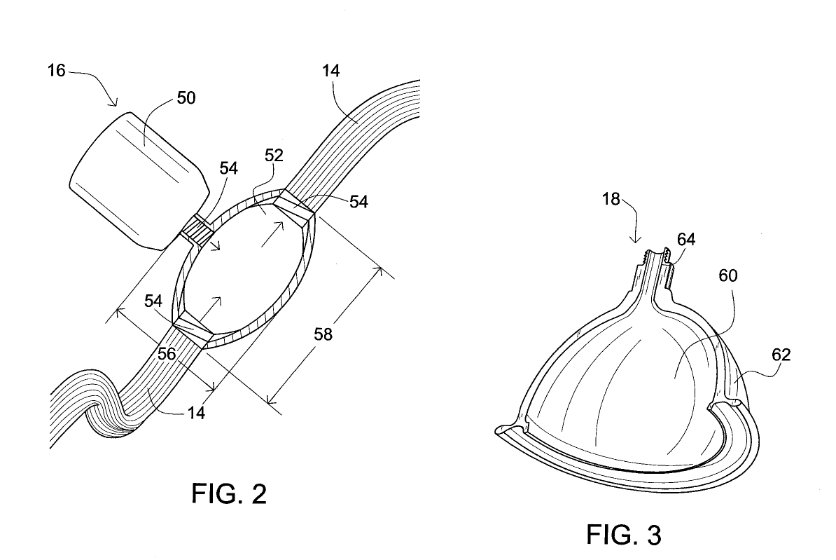

In one embodiment, the sanitation system 16 may be coupled to the tubing 14, as best shown in FIG. 2. The sanitation system may be coupled to a first tube or second tube center portion. The sanitation system may not dissect the tube. Furthermore, the sanitation system may couple to the first tube distal end 72 and the second tube proximal end 73. The fluid inlet port may be coupled to the first tube proximal end 70 and the outlet port may be coupled to the second tube distal end 74.

In one embodiment, the sanitation system 16 may be comprised of a solution container 50 and a container adapter 52. The adapter may be substantially hollow and have three ports 54. The ports may be threaded. The ports may also be adapted to couple to the press plug connector 40 shown in FIG. 1B, or any other similar snappably or non-similar coupling connector. One port may be adapted to receive the solution container. One solution container may be contain a cleaning solution such as, but not limited to, Vital Oxide manufactured by Vital Technologies, Inc. of Hope Sound, Fla. One solution container may be comprised of a valve adapted to release a specified amount of cleaning solution into the water. For example, the valve may be adapted to release a specified amount of cleaning solution into the water for a given water flow rate. One such valve may be a venturi-flow valve. In one embodiment, the valve may operate similar to the valves in garden hose attachments wherein the valve is adapted to release an amount of fertilizer, or another lawn or garden care solution, into the water stream. One embodiment of a container may have a length 58 of about 3.65 inches or about 7.65 inches, and a height 56 of about 2.5 inches. One solution container may hold about 8 ounces of solution.

As seen in FIGS. 1A and 4, after the sanitation system 16, a tube 14 may carry the water/solution mixture to the fluid outlet port 18. The fluid outlet port may also be referred to as a water intake coupling mechanism. One fluid outlet port may be comprised of a cavity portion 60, a suction portion 62, and a tube connection portion 64, as best shown in FIG. 3. The fluid outlet port is adapted to transfer the mixture to the intake port 61 in one embodiment as shown through the cut-away fluid outlet port cavity portion in FIG. 4. The intake port may also be referred to as a jetted system water reception port, a jetted system fluid intake port, or a water jet intake port. One water outlet port may be referred to as a universal water outlet port as it may be adapted to couple to various water system intake ports sizes and shapes.

In one embodiment, the cavity portion may be located between the tube connection portion and the suction portion. The tube connection portion may be threaded or may couple to the tube 14 with another known connector apparatus. As mixture may exit the tube connection portion 64 at a high flow rate, the mixture may tend to gather within the cavity portion prior to entering the intake port 61, especially if the lines the mixture is intended to clean are significantly clogged. Therefore, the cavity portion may have a large enough cavity to receive the mixture without allowing the mixture to back up into the tube connection portion.

### One Method of Cleaning a Jetted Fluid System:

As shown in FIG. 4 one method of cleaning a jetted fluid system may comprise using a jet system cleaning device 10. In so doing, the method may include receiving a fluid into an inlet port 12, as seen in FIGS. 4 and 6. The fluid may be water received from a faucet 30. The device may mix a cleaning solution with the fluid. For example, as best shown in FIGS. 1A and 2, in one method a sanitation system 16 may release a liquid cleaning solution into the fluid between the inlet port and an outlet port 18. Non-liquid cleaners may also be used in one method—for example, a powder, a solid, a cake, or a gelatinous cleaning solution may be used. Upon reception of the solution/fluid mixture by the outlet port, the mixture is transferred to a jetted system water intake port 61 in one method. The mixture then enters the jetted fluid system, cleaning the portions of the system the mixture comes into contact with, potentially removing mold, bacteria, or other unwanted items on the system parts. One jetted fluid system may be a bathtub 100 having jets 102, as best shown in FIG. 4. The mixture may be ejected from the jets 102, traveling down the system drain 104.

To circulate the water/cleaning solution mixture in one method, the bathtub 100 jet system may need to be powered on. This may induce a pump to receive the water/solution mixture into the intake port 61 and potentially into a part of the pump. The pump may then pump the mixture from the intake port through the system lines to the jets 102. In one method, the outlet port 18 may need to sealedly couple to a bathtub proximate the intake port. This may occur with a suction portion 62, as best shown in FIG. 3. The suction portion may couple to a bathtub wall surrounding the intake port. Once secure to the tub, the water/cleaning solution mixture may enter the system and substantially coat the inner surface of the tubes, pipes and jets 102, substantially removing and preventing growth of bacteria, mildew, and mold on these surfaces.

To receive a sufficient amount of water so that the jetted water system 10 may be adequately cleaned in one method, the inlet port 12 may be coupled to the faucet 30 with an elastomeric or flexible polymeric material having a conduit section 20 and a strap section 22, as best shown in FIG. 6. The conduit section may be adapted to receive the faucet. The strap section may be adapted to wrap around the conduit section, squeezing the bore 24 so that the bore diameter 38 is decreased. The bore diameter may decrease to a point where the bore diameter is generally equal to the faucet diameter 39. The inlet port may then be substantially secured in a tightened position. The tightened position may also be referred to as a coupling position. For example, in one method, a strap extension 23 may be placed through a strap bore 21. At this point, the inlet port 12 may be substantially coupled to the faucet. Other methods may be adapted to couple the inlet port to a fluid outlet device other than a faucet or another portion of the device 10 may be used to receive fluid.

As best seen in FIG. 2, one method of mixing a solution with water may be comprised of using a solution container 50 and a container adapter 52. The solution container may be comprised of a liquid cleaning solution such as, but not limited to Vital Oxide manufactured by Vital Technologies, Inc. of Hope Sound, Fla. Furthermore, the solution container may be comprised of a coupling mechanism adapted to couple the container to the device 10 (the device best shown in FIG. 4). One coupling mechanism may be a threaded port, although other mechanisms are contemplated. In one method the container may be adapted to couple to the container adapter and the adapter may couple to a device element such as, but not limited to one or more tubes 14. The solution container or the container adapted may have a venturi flow valve which is adapted to release liquid or gelatinous cleaning solution from the solution container into the fluid.

### ALTERNATIVE EMBODIMENTS

The embodiments of the fluid jet cleaning device and methods of use as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure.

One alternative embodiment may be comprised of a fluid inlet port that is adapted to receive a fluid other than water or that may be adapted to receive water from a device other than a faucet. For example the fluid inlet port may receive a cleaning solution/water mixture from a pump. Furthermore, a system is contemplated that receives water from a dedicated water line. In this type of system, the water line may be installed with the jetted bathtub to allow for easy cleaning of the bathtub water lines. In this, or another similar manner, the dedicated water line may be similar to dedicated water lines for refrigerators.

I claim:

1) A device comprising,
a fluid inlet port;
at least one tube coupled to the inlet port, the at least one tube adapted to transport a fluid from the inlet port to a fluid outlet port, the fluid outlet port adapted to release a mixture to a jetted system fluid intake port; and
a sanitation system operatively coupled to the at least one tube, the sanitation system adapted to insert a cleaning solution into the fluid to create a solution-fluid mixture.

2) The device of claim 1 wherein, the fluid inlet port is adapted to receive water from a jetted bathtub faucet.

3) The device of claim 1 wherein,
the at least one tube comprises,
a first tube, the first tube comprising a proximal end and a distal end, and
a second tube, the second tube comprising a proximal end and a distal end;
the fluid inlet port is coupled to the first tube proximal end;
the sanitation system is coupled to the first tube distal end and the second tube proximal end; and
the fluid outlet port is coupled to second tube distal end.

4) The device of claim 1 wherein,
the at least one tube comprises one tube; and
the sanitation system is coupled to a tube center portion without dissecting the tube.

5) The device of claim 1 wherein, the sanitation system comprises a venturi flow valve.

6) The device of claim 1 wherein, the fluid inlet port comprises,
a generally flexible conduit section comprising,
a proximal end comprising a generally universal faucet interface adapter,
a distal end adapted to couple to a corrugated tubing; and
a faucet coupling mechanism.

7) The device of claim 6 wherein, the faucet coupling mechanism comprises, a flexible strap portion comprising a plurality of bores and an extension, the faucet coupling mechanism adapted to couple the fluid inlet port to a jetted bathtub faucet.

8) The device of claim 1 wherein, the fluid outlet port comprises,
a connection portion;
a suction portion; and
a cavity portion, wherein the cavity portion is adapted to receive and allow the mixture to exit the device.

9) The device of claim 1 wherein, the sanitation system comprises,
a container adapter section, the container adapted section adapted to couple to the at least one tube; and
a solution container adapted to release cleaning solution into the water.

10) A method of cleaning a jetted fluid system using the device of claim 1 comprising,
sending a fluid into the inlet port;
placing a cleaning solution into the fluid;
creating a fluid-solution mixture;
ejecting the mixture from the fluid outlet port into a jetted system intake port; and
cleaning at least one of a jetted fluid system pipes, tubes and jets.

11) A method of cleaning jetted fluid systems comprising,
coupling a device fluid inlet port to a faucet;
coupling a device fluid outlet port to a water jet system intake port;
drawing water from the faucet into the inlet port;
adding a cleaning solution to the water to create a mixture;
ejecting the mixture from the fluid outlet port to the water jet intake port;
powering on the water jet system;
cleaning at least one of jet tubes, pipes and jets with the mixture;
ejecting the mixture from the jets; and
allowing the mixture to travel down the drain.

12) The method of claim 11 wherein said coupling a device fluid inlet port to a faucet comprises,
inserting a jetted bathtub faucet into a fluid inlet port conduit bore;
wrapping a fluid inlet port strap around the conduit;
decreasing the conduit bore diameter; and
securing the strap in a coupling position.

13) The method of claim 11 wherein, said adding a cleaning solution to the water comprises,
receiving the water into a sanitation system, the sanitation system comprising,
a solution container,
a container adapter; and
sending cleaning solution through a venturi valve.

14) The method of claim 11 further including, coupling the outlet port proximate the jet water intake port by using an outlet port suction portion.

15) The method of claim 11 wherein, said cleaning at least one of the jet tubes, pipes, and jets comprises,
flowing a mixture of water and Vital Oxide™ along at least one of an inner surface of the jet tubes, pipes, and jets, and wherein, the at least one of jet tubes, pipes and jets have at least one of bacteria, mold, and mildew adhered to the inner surface; and
substantially removing the one of bacteria, mold and mildew from the inner surface; and
impeding growth of the one of bacteria, mold and mildew.

16) The method of claim 11 wherein, said powering on the water jet system comprises,
drawing fluid into a pump part; and
sending water through at least one of jet tubes, pipes and jets.

17) A combination comprising,
a jetted bathtub comprising a faucet and a water intake port;
a cleaning solution; and
a fluid jet system cleaning device adapted to, (i) take water from the jetted bathtub faucet, and (ii) insert the water into the jetted bathtub water intake port.

18) The combination of claim 17 wherein, the jetted bathtub comprises a Jacuzzi® system.

19) The combination of claim 17 wherein, the cleaning solution comprises one of a powder and a liquid.

20) The combination of claim 17 wherein, the fluid jet system comprises a venturi valve.
